(19) United States
(12) Patent Application Publication
(10) Pub. No.: US 2024/0061884 A1
(43) Pub. Date: Feb. 22, 2024

(54) SELF-ADAPTIVE FILTERING OF DATA HAVING TREE STRUCTURES

(71) Applicant: Hewlett-Packard Development Company, L.P., Spring, TX (US)

(72) Inventors: Jiahao Zhou, Shanghai (CN); Shu-Wu Shi, Shanghai (CN); Wen-jie Jiang, Shanghai (CN)

(73) Assignee: Hewlett-Packard Development Company, L.P., Spring, TX (US)

(21) Appl. No.: 17/820,672

(22) Filed: Aug. 18, 2022

(51) Int. Cl. G06F 16/901; G06F 16/9035; G06F 40/58

(52) U.S. Cl. CPC G06F 16/9027; G06F 16/9035; G06F 40/58

(57) ABSTRACT

A self-adaptive data filter is developed to process data having tree-structured formats, such as, JSON, XML, and YML. Unlike conventional data filtering methods, which require different filters for different data structures, in one aspect, the disclosed self-adaptive data filter is data structure agnostic and can be used to process a wide variety of data structures. In another aspect, the self-adaptive data filter of this disclosure allows for fuzzy search.

### BACKGROUND

Conventionally, to filter data from multiple data structures or models (e.g., JSON data structures 1 through N), multiple filters (e.g., filters 1 through N) must be built respectively for the corresponding data structures and/or models. When one of the data structures or models has changed, the corresponding filter must also be changed.

### BRIEF DESCRIPTION OF THE DRAWINGS

FIG. 1 illustrates an example data model in a tree-structured format.

FIG. 2 illustrates an example whitelist filtering process performed to the data model as shown in FIG. 1.

FIG. 3 illustrates an example self-adapter filter apparatus of this disclosure.

FIG. 4 illustrates an example input addon catalog in XML format.

FIG. 5 illustrates an expected/filtered output addon catalog from the example input addon catalog as shown in FIG. 4.

FIG. 6 illustrates an example filter configuration that can be used to generate the output addon catalog of FIG. 5 from the example input addon catalog of FIG. 4.

FIG. 7 illustrates an example input addon catalog in a tree-structured format with certain lowest level nodes being removed.

FIG. 8 illustrates an example input addon catalog in a tree-structured format with certain second lowest level nodes being removed.

FIG. 9 illustrates an example input addon catalog in a tree-structured format with certain third lowest level nodes being removed.

FIG. 10 illustrates an example output addon catalog in a tree-structured format.

FIG. 11 illustrates an example filter adaptive to three types of input catalogs.

FIGS. 12A and 12B respectively illustrate an input catalog and an output catalog in YML format before and after filtering.

FIGS. 13A and 13B respectively illustrate an input catalog and an output catalog in JSON format before and after filtering.

FIGS. 14A and 14B respectively illustrate an input catalog and an output catalog in XML format before and after filtering.

FIGS. 15A and 15B respectively illustrate an input catalog and a desired output catalog in XML format for a first example company.

FIGS. 16A and 16B respectively illustrate an input catalog and a desired output catalog in JSON format for a second example company.

FIGS. 17A and 17B respectively illustrate an input catalog and a desired output catalog in YML format for a third example company.

FIG. 18 illustrates an example filter adaptive to a wide variety of reports.

FIG. 19 illustrates an example filter capable of filtering addons catalog against platform whitelist and OS blacklist using a filter chain.

FIG. 20 illustrates an example filter capable of filtering addons catalog using conditions.

FIG. 21 illustrates an example filter capable of filtering addons catalog using object referencing.

### DETAILED DESCRIPTION

Data filtering is usually a pre-processing operation in a software or a system. The filter system disclosed herein is adaptive to most data models, such as JSON, XML, and YML formats. In this disclosure, the addons catalogs are used as an example.

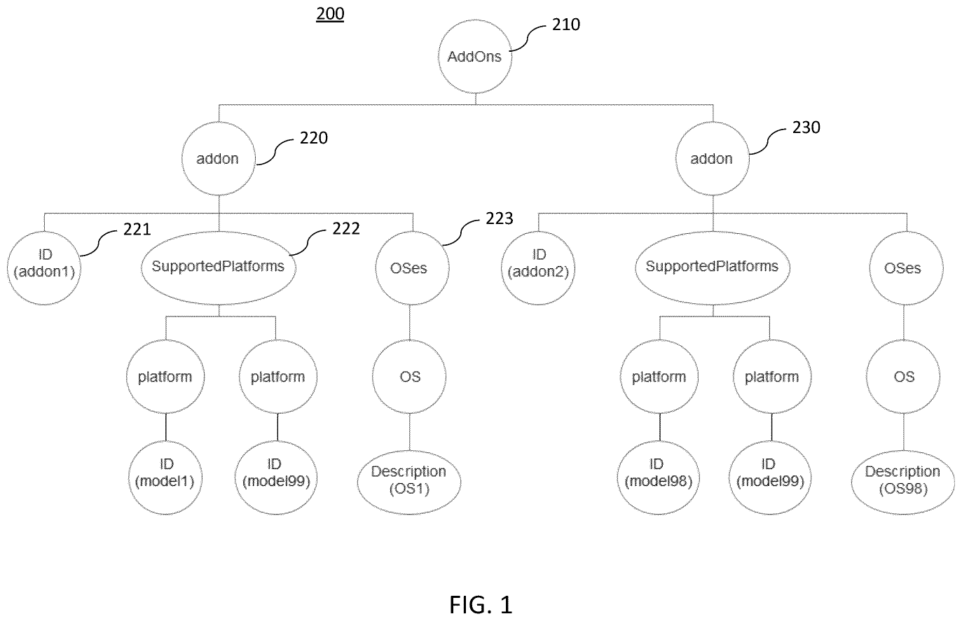

FIG. 1 illustrates an example data model 200 in a tree-structured format. As shown in this example, tree-structured data model 200 can be represented as a hierarchical system starting at the topmost level from a root node 210 (“AddOns”), dividing into branches at the next level from nodes 220, 230 (“Addon”), and further dividing into additional branches at the lower levels from, for example, nodes 221, 222, 223 (“ID,” “SupportedPlatforms,” “OSes”), etc., to be further detailed below.

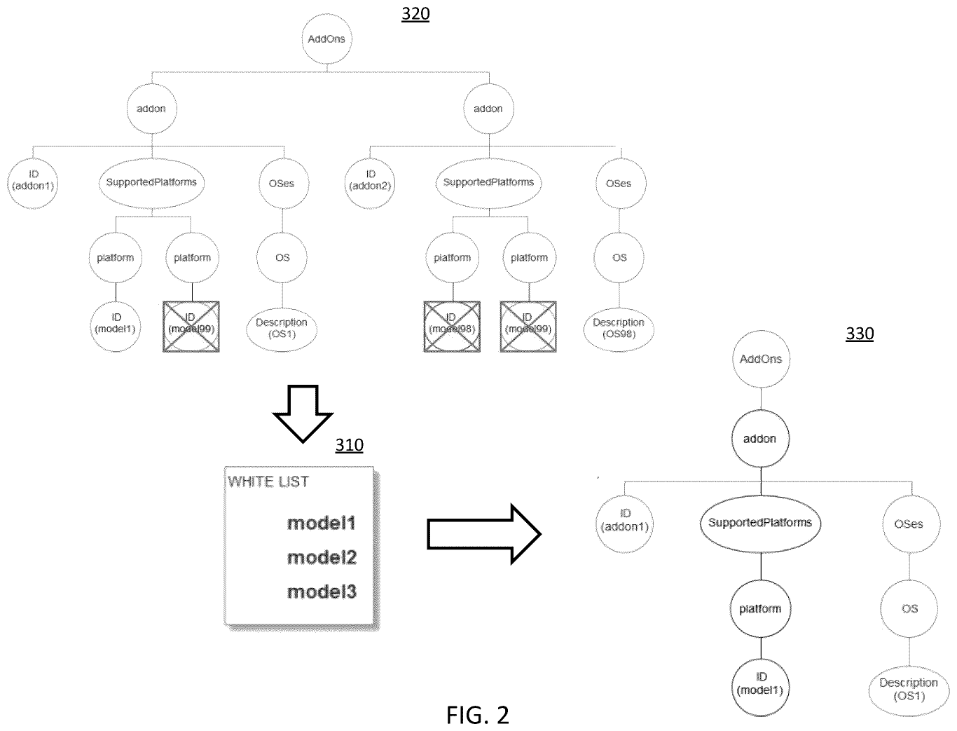

FIG. 2 illustrates an example whitelist filtering process performed to data model 200 of FIG. 1. A filter removes data that does not meet certain criteria from the input data and generates the remainder of the input data as the output data. As shown in FIG. 2, criteria 310 is to whitelist (allow or approve) a group of models (e.g., “model1,” “model2,” and “model3”) from input data 320. As a result, output data 330 eliminates all models that do not belong to the whitelisted models.

Self-Adaptive Filter System Architecture

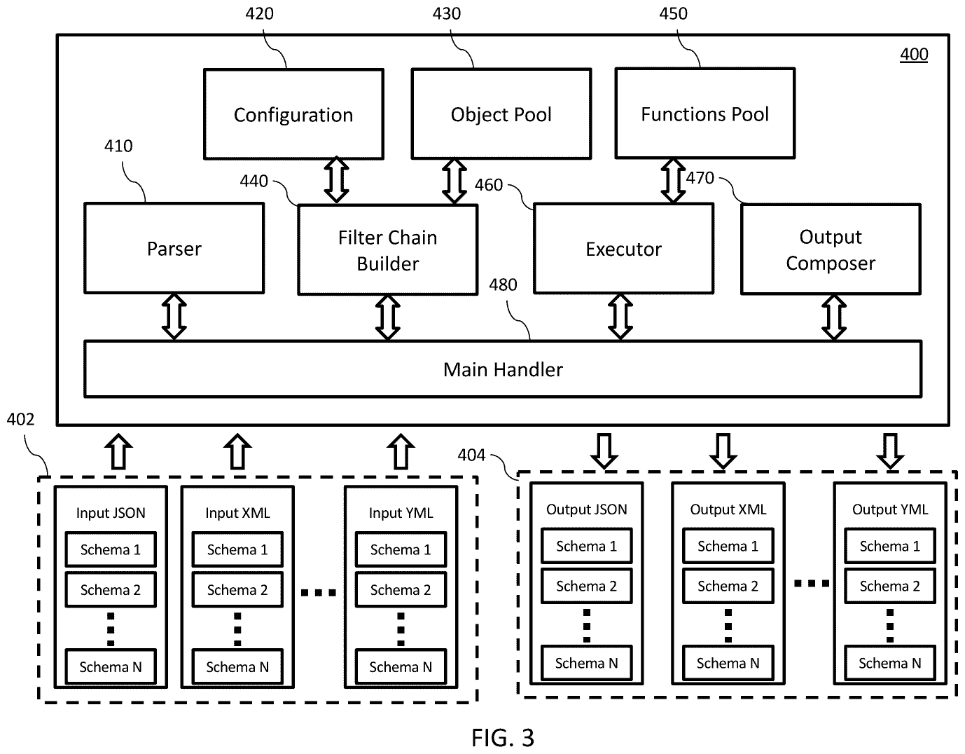

FIG. 3 illustrates an example self-adapter filter apparatus or system 400 of this disclosure, which can largely be divided into two components, i.e., an extensible data loader and a filter. The extensible data loader understands a wide variety of commonly known data format, which allows the incorporation of any new data format in the future. The goal for the extensible data loader is to generate a common in-memory model. On the other hand, the filtering rule dictates how the filtering engine performs its works. The most powerful part of this component is to include aliases and dynamic/smart translations. One can define a keyword in the English language which can be automatically translated into the source language. For example, one can define a keyword “Artist” in English and automatically use keyword “Artista” in Spanish, because the source is detected to be in the Spanish language. In addition, one can create aliases/synonym for known words. For example, one can define “Title,” “Song Name,” and/or “Title Name” as being equivalent (“˜”) to each other.

As shown in FIG. 3, system 400 may include a parser 410, a configuration file 420, an object pool 430, a filter chain builder 440, a functions pool 450, an executor 460, an output composer 470, and a main handler 480. In one example, system 400 can build filters based on data configuration. Input data 402 of any format can be parsed as a tree structure for target locators to search and filter. Output data 404 can be transformed into any suitable format or a different data schema.

In one example, parser 410 is the extensible data loader that parses a wide variety of commonly known data formats, such as, JSON, XML, and YML. It can also parse data models in any programming language, such as, C and Java, and allows for the incorporation of new data formats in the future. The goal for parser 410 is to generate a common in-memory model which has a tree structure (“tree”).

In one example, configuration file 420 can be in an YML format, which defines one or more filters including a rule.

In one example, object pool 430 stores predefined objects of any type in configuration file 420, such as target locator(s), filter(s) and condition(s). Referencing those objects in configuration file 420 serves the reusable purpose.

In one example, filter chain builder 440 reads configuration file 420 and object pool 230 to build filters, so that filters are ready for execution.

In one example, functions pool 450 stores all predefined functions which are used in criteria or matching a node in the target locators. Users can add custom functions to expand functions pool 450.

In one example, executor 460 executes the filters to filter the content and remove invalid branches from the tree. Executor 460 may pull pre-defined functions as specified in the filters by accessing functions pool 450.

In one example, output composer 470 composes outputs in a flexible way and transforms output data in its original tree-structured format into that of another format. Output composer 470 also supports reorganizing the output content so that the original tree structure can be converted into a new tree structure. As detailed below, a filter will traverse all nodes when filtering content, so it is very easy to reorganize the nodes and create another tree. It also supports template technology to help reorganization.

In one example, main handler 480 organizes the whole flow by handling inputs and outputs, transmitting data among the internal components, including parser 410, filter chain builder 440, executor 460, and output composer 470.

System 400 may be implemented as hardware, software, firmware, or a combination thereof.

Self-Adaptive Filtering Process

Hereafter, the self-adaptive filtering process is to be described in further detail. After a tree is created, a rule as defined in configuration file 420 can be used to filter content. The rule is mainly composed of two key parts, i.e., “criteria” and “target locators.”

The criteria are a collection of one or more operators, expressions, predefined functions to verify values that a target locator finds. Common criteria includes “greater than” (“>”), “less than” (“<”), “equal to” (“==”), regular expressions, and predefined functions, such as, “in” which can be used as whitelist. It is appreciated that custom functions can be added to functions pool 450 to verify values, such that criteria can be easily extended and enhanced.

The target locators can find the field to be verified against the criteria. Because the commonly known data formats (e.g., JSON, XML, YML) are in a tree structure, any field can be considered as a node of the tree. Accordingly, the target locators can use a syntax abstracted from those tree-structured formats to locate a node on the tree and describe a path from the root to the node that is being searched. The target locators can also define the boundaries of invalid data that is to be deleted. In one example, target locators can be stored in a data array.

A target locator mainly includes the following four components:
1. Node Name: the name of a node on the tree and a keyword that can be defined.
2. Dot Delimiter: a dot (“.”) to separate parent and child nodes.
3. Array Indicator: a pair of square brackets (“[” and “]”) to indicate that the part to its right is an array.
4. Deletion Boundary: a colon (“:”) to specify the start location of invalid branches to be deleted. For example, when one checks the platform for every “addon,” the boundary is the “<addon>” node on the tree. If one “addon” does not have a valid platform, the complete “addon” branch is to be deleted.

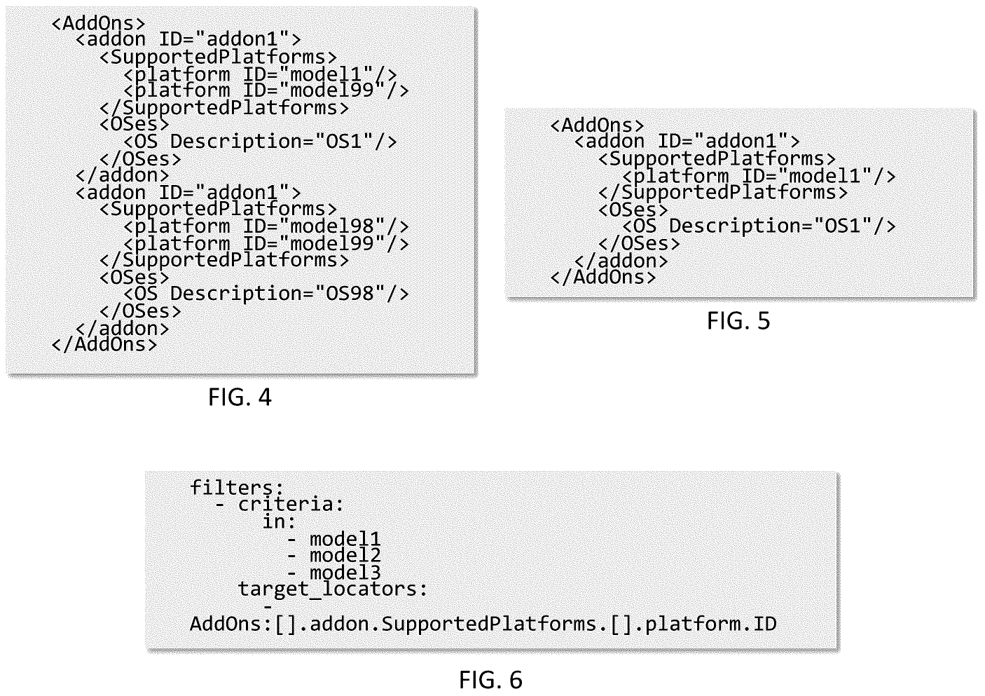

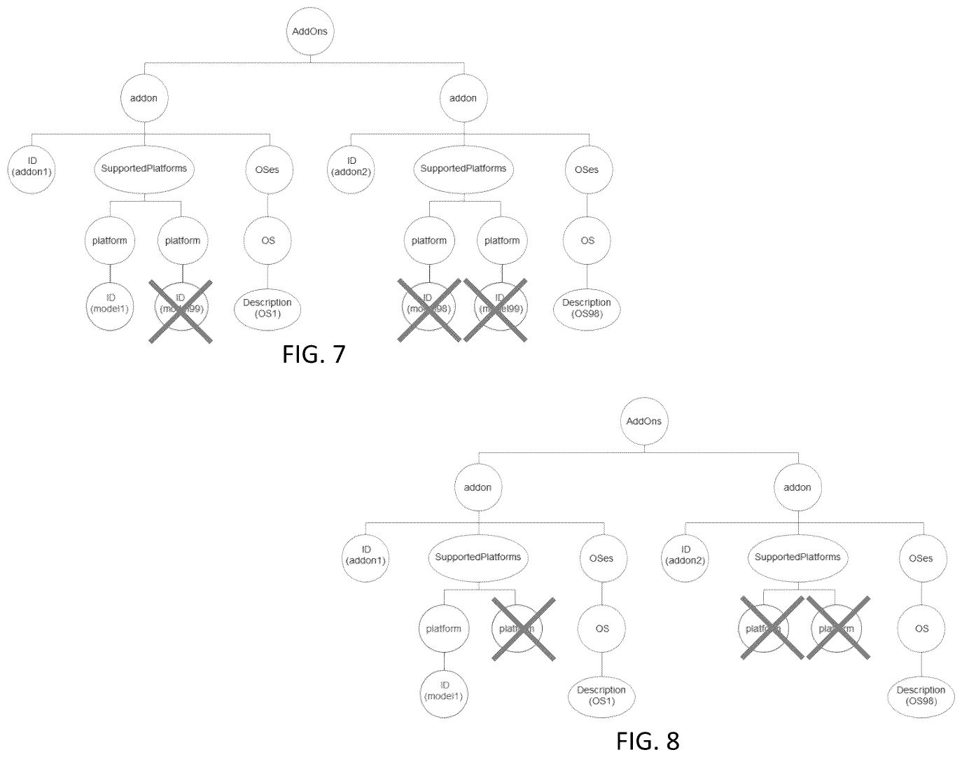

FIG. 4 illustrates an example input addon catalog in XML format. In one example, the goal is to filter the input addon catalog with a criterion, such that the “platform” in the input addon catalog should be in a whitelist of, e.g., [model1, model2, model3]. That is, any unsupported platform (e.g., neither model1, nor model2, nor model3) should be removed from the addon catalog. If an addon does not have any supported platform, it should also be removed from the input addon catalog. FIG. 5 illustrates an expected/filtered output addon catalog (in XML format) from the example input addon catalog as shown in FIG. 4.

FIG. 6 illustrates an example filter configuration (e.g., in YML format) that can be used to generate the output addon catalog of FIG. 5 from the input addon catalog of FIG. 4. In this example, the target_locators include the following string:
AddOns:[ ].addon.SupportedPlatforms.[ ].platform.ID
   This is essentially a path to search the field “ID.” The first segment “AddOns” is the start which is corresponding to the root tag “AddOns” of the input addon catalog. The following colon “:” is a deletion boundary. Then, square brackets “[ ]” indicates the following content will be an array type. Next, “addon” is a child node of “AddOns.” Therefore, the filter system can easily locate “ID” in the input along this path and use criteria to verify.

The following steps are performed to filter the content.

Step 1: If the field of an “ID” node does not meet the criteria, the “ID” node is to be removed. Moreover, the “ID” node itself with all its descendants are marked as invalid branches. Because the “ID” node is removed, its corresponding branch does not satisfy the corresponding part of the path that is described by the target locator. In this example, “ID” nodes of “model98” and “model99” and their corresponding branches are to be removed, as shown in FIG. 8.

Step 2: System 400 travels back to from each removed “ID” node to its parent “platform” node to see if “platform” is a valid branch. Because the “platform” does not have any children of an array type and the only child “ID” node is deleted, the “platform” node is also to be removed, as shown in FIG. 8.

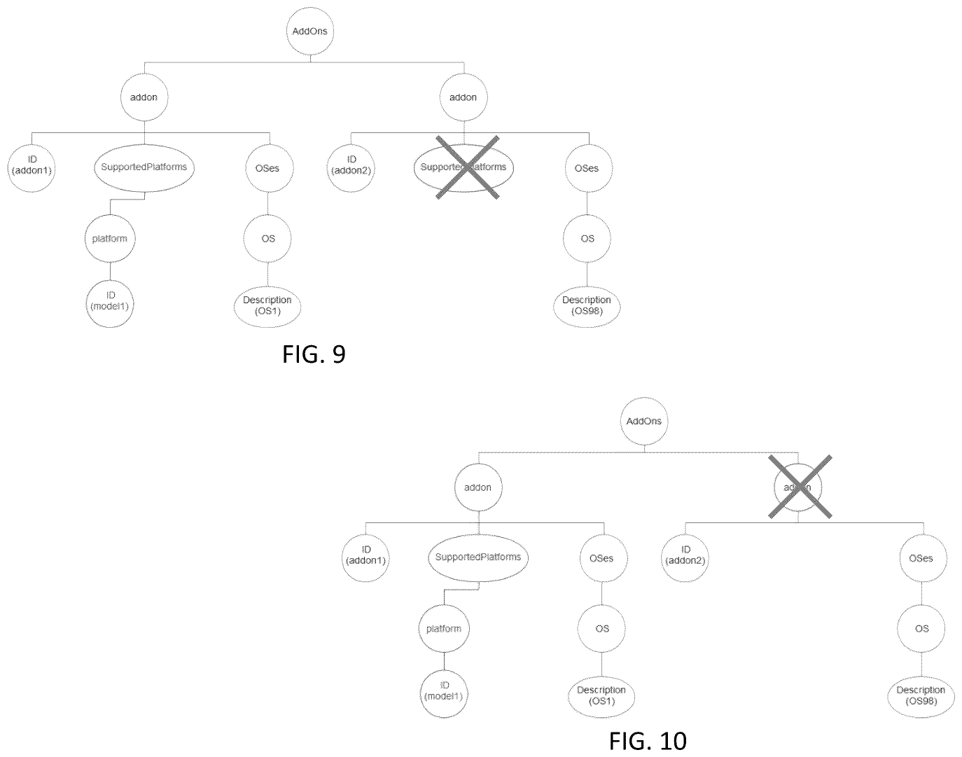

Step 3: System 400 travels further back from each removed “platform” node to its parent node “SupportedPlatforms” to see if any of the “SupportedPlatforms” is a valid branch. As described by the target_locators, the “SupportedPlatforms” has a child of an array type. As for “addon1”, the branch from “SupportedPlatforms” to “ID=model1” is a valid branch. Therefore, this branch is not to be deleted. As for “addon2,” none of the branches from “SupportedPlatforms” is valid. Therefore, this node will be removed, as shown in FIG. 9.

Step 4: As described previously, system 400 checks to determine whether any of the “addon” nodes is to be removed. Because none of the branches below the “addon” node to the right includes any field that satisfies the filter criteria, it is to be deleted. As a result, an output addon catalog in tree-structure is generated, as shown in FIG. 10. No more steps are to be performed after Step 4, because a deletion boundary (i.e., colon) is met. In this example, output data 330 as shown in FIG. 2 is the final result after filtering.

Filtering for Multiple Catalogs

In one aspect, the filtering process described above can be used to filter data having multiple heterogeneous data structures. As discussed above, the target locator can describe the most common tree-like formats, such as, JSON, YML, and XML. One target locator can describe a path that is matched with one data structure, while another target locator can describe a path that is matched with another data structure. As such, a target locator array can describe a collection of paths, thereby making the filter capable of being matched with multiple data structures.

In order to accept an input of any data structure, the filter first loads its target locator and determines which target locator is more applicable by traversing the tree converted from the input along the paths that are described by the target locators. The most matched target locator will be used to filter the content.

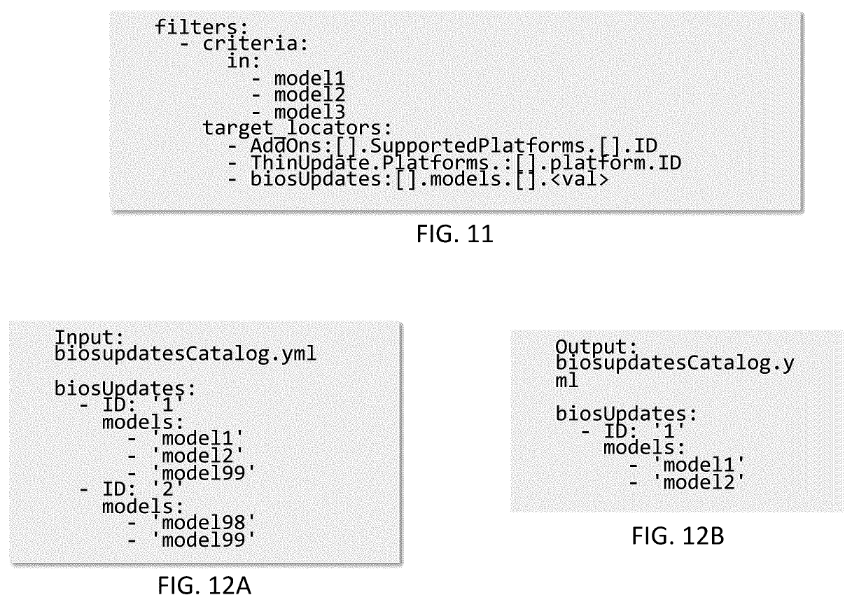

FIG. 11 illustrates an example filter adaptive to three types of input catalogs. In this example, the three types of input addon catalogs are addons, bios updates, and images. These three types have different tree structures, and they can be in different formats. The filtering goal is to retrieve addons, bios updates, and images, which support platforms in a whitelist of [mode1, model2, model3].

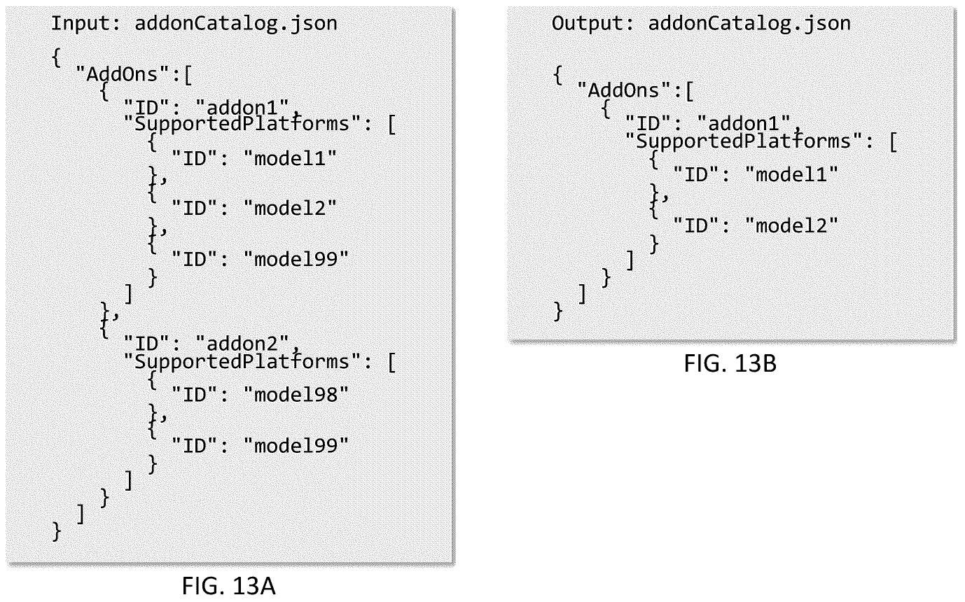

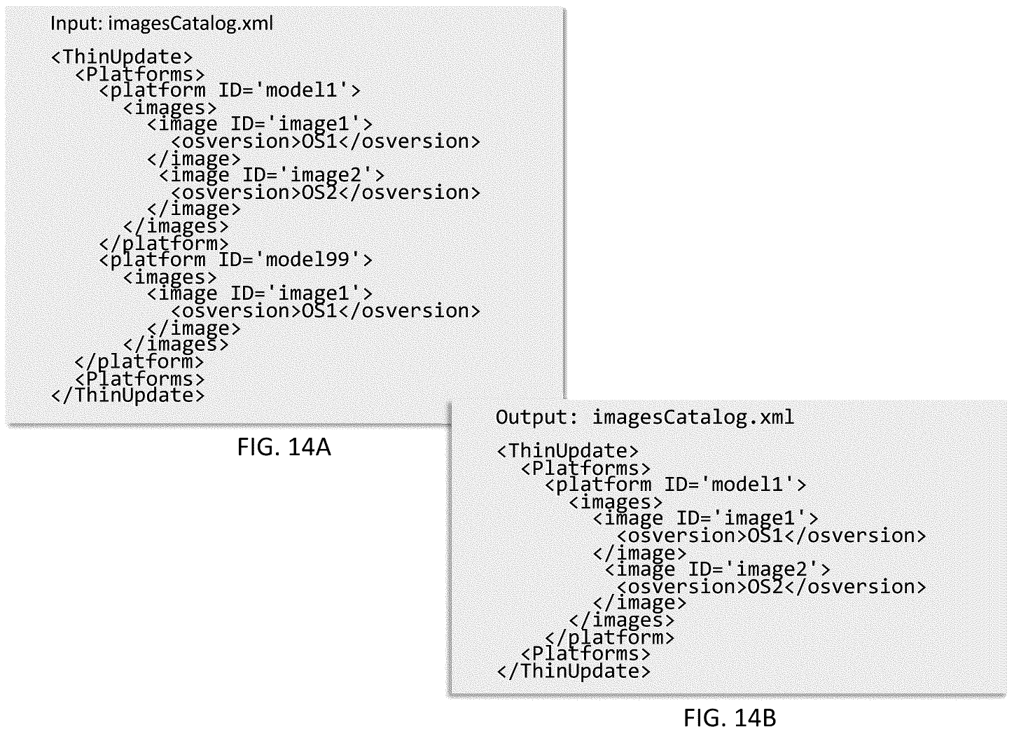

FIGS. 12A and 12B respectively illustrate an input catalog and an output catalog in YML format before and after filtering. FIGS. 13A and 13B respectively illustrate an input catalog and an output catalog in JSON format before and after filtering. FIGS. 14A and 14B respectively illustrate an input catalog and an output catalog in XML format before and after filtering. Using the filter as shown in FIG. 11, system 400 can generate output catalogs as shown in FIGS. 12B, 13B, and 14B respectively from input catalogs as show in FIGS. 12A, 13A, and 14B.

Fuzzy Search for Extended Adaptivity

The ability to process more target locators generally means that a filter is more adaptable. Oftentimes, however, it is not easy to handle too many target locators, because a target locator can be built only if the corresponding data structure is known. For unknown data structures, system 400 allows for fuzzy search in target locators. As such, the path described by a target locator can be more flexible, conceptually more abstract, and/or incomplete.

In one example, the components of a target locator can be extended as follows:

1. Node name: an exact name of a field or an expression that could be a predefined function, a custom/user defined function to extend the predefined function in functions pool 450, and/or a regular expression. Dynamic and static translation can also be applied to the node name. For dynamic translation, system 400 can automatically use third party translation services available via a wide area network (e.g., translate.google.com) to do keyword translation and use automatic source input detection. For static translation, system 400 can get translation from the pre-defined translations pool that user can add translations for the keywords. Left and right angled bracket (“<” and “>”) can be used to enclose the expression. For example, “<i18n, synonym(profit)>” means that any words that is a synonym of the word “profit” (e.g., “gain,” “earnings,” “yield”) or a translation of the word “profit” in another language (e.g., “Gewinn,” “ [symbol] ”) can be matched.

2. Dot delimiter: a dot (“.”) to separate parent and child nodes.

3. Array Indicator: a pair of square brackets (“L” and “1”) to indicate that the part to its right is an array.

4. Deletion boundary: a colon(“:”) to specify the start location of invalid branches to be deleted.

5. Wildcard an ellipsis (“ . . . ”) to match any part of path on the tree.

In one example, a government wants to collect profit reports from all companies that it manages. The reports use a variety of tree structures to organize their content in different languages. The only known similarities of the reports are that all reports list department information, months, and profits. The government is interested in learning which department in which month earns more than one million dollars. Therefore, a report can be transformed into a tree structure with a top node of “departments,” followed by a department information array as descendant, which may include an array of months and the corresponding profits.

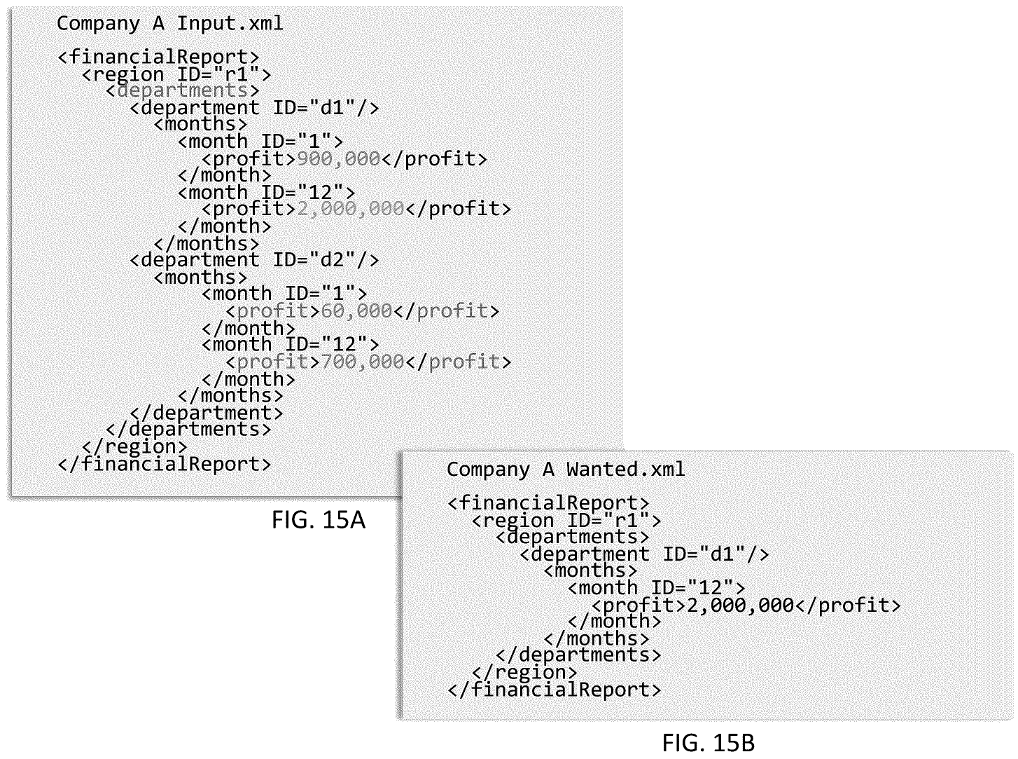

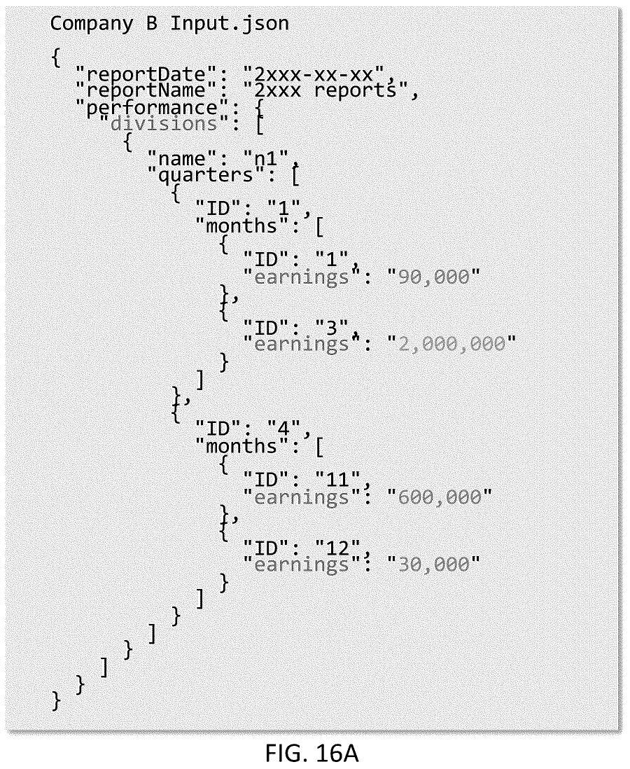

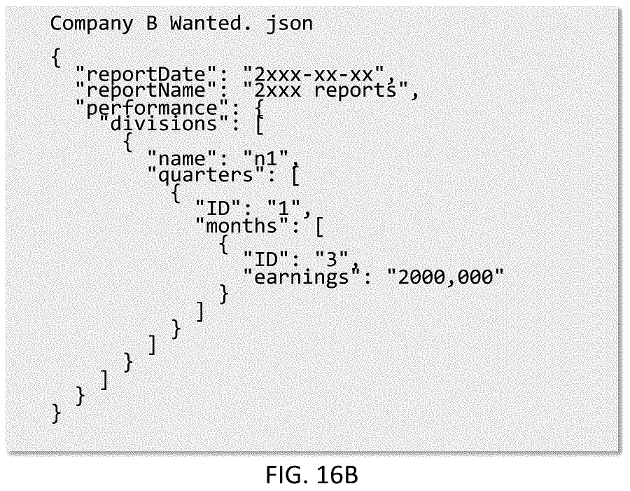

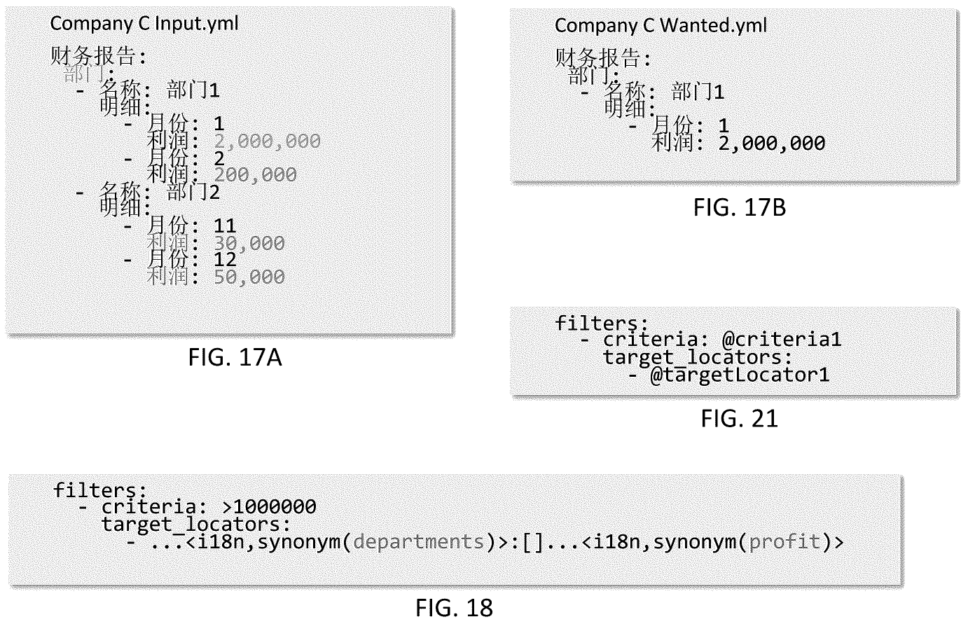

FIGS. 15A and 15B respectively illustrate an input catalog and a desired output catalog in XML format for a first example company. FIGS. 16A and 16B respectively illustrate an input catalog and a desired output catalog in XML format for a second example company. FIGS. 17A and 17B respectively illustrate an input catalog and a desired output catalog in XML format for a third example company. Note that “divisions” is synonymous to “departments,” and “earnings” is synonymous to “profit.” Also note that “ [symbol] ” is a Chinese translation of “departments,” and “ [symbol] ” is a Chinese translation of “profit.”

FIG. 18 illustrates an example filter adaptive to a wide variety of reports. In one example, system 400 can use the filter in FIG. 18 to process input catalogs in FIGS. 15A, 16A, and 17A, and generate output catalogs in FIGS. 15B, 16B, and 17B. This example shows the working principle of a fuzzy target locator. It is appreciated that more target locators can be placed in a filter. Before filtering, a filter can test all target locators and choose the best one. It is appreciated that a regular target locator (without a wildcard) almost always outperforms a fuzzy target locator (with a wildcard).

Other Features

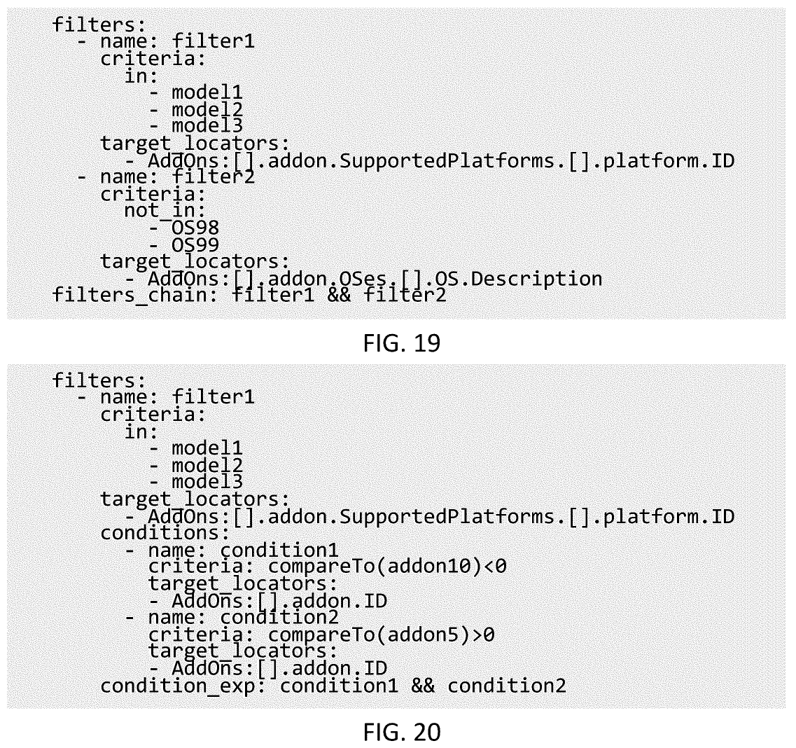

FIG. 19 illustrates an example filter capable of filtering addons catalog against platform whitelist and OS blacklist using a filter chain. The filter chain, which can be generated by filter chain builder 440, defines the execution of filter combinations. Each filter has a name defined by the “name” field. If no filter name is defined, the default name will be in form of “filterN,” where N is a natural number. The filter chain as shown in FIG. 19 includes the combination of two filters, i.e., “filter1” and “filter2.” The filters can be combined using an operator, such as, “&&” and “∥.” The “&&” operator means that the filters are in cascade, while the “∥” means that the filters are in parallel.

In one example, the “&&” operator executes the two filters in series. That is, the output of filter1 becomes the input of fitler2. Specifically, for example, the input data goes to filter1 (whitelist filter) first to remove unsupported platform. Then, the filtered data goes to filter2 (OS blacklist) to remove unsupported OS. The overall result satisfies BOTH the platform whitelist and the OS blacklist. In one example, the “∥” operator processes the two filters at the same time. Specifically, for example, the input of filter1 and the input of filter2 are connected, such that the two filters have the same input data. That is, the raw data goes to both filter1 and filter2. Then, the output of these two filters are merged. The overall result satisfies EITHER the platform whitelist OR the OS blacklist. If no filters_chains are in the configuration, all filters are in cascade by default.

FIG. 20 illustrates an example filter capable of filtering addons catalog using conditions. Conditions perform content check before filtering. Each Condition has a structure similar to that of a filter, which includes target_locators and criteria. When a filter finds a target node by its target_locators, it will then check if the conditions are met. If the conditions are not met, no filtering is to be performed on that node. The path from the root node to this node is the place where condition search its target node to verify against the criteria. Condition_exp is an expression of all conditions. The expression supports logical operations. For instance, the conditions in FIG. 20 will only filter content on the addons of which the “ID” is from “addon5” through “addon10.”

FIG. 21 illustrates an example filter capable of filtering addons catalog using object referencing. An object can be referenced using an “at” symbol (“@”) in front of an object name defined in object pool 430. For example, “targetLocator1” can be defined as “AddOns: [ ].addon.SupportedPlatforms. [ ].platform. ID” in object pool 430, while “criteria1” can be defined as whitelist [model1, model2, model3] in object pool 430. These objects can be referenced by a filter in configuration file 420 as @targetLocator1 and @criteria1. Object referencing helps to reuse any predefined object from the objects pool in the configs.

Possible Applications

In addition to the examples described above, system 400 can be used to filter songs or music files from song/music listings of different companies, which have different ways of formatting and/or organizing song/music data. Regardless of data structures, typical songs from different companies always have the common information, such as, names, release date, genres, producer, and so on. As a result, keywords can be defined in system 400 including their aliases to create a list of rules for the self-adaptive filter engine. The data can be stored in a database using any suitable formats, such as, XML, JSON, YML, etc. System 400 can traverse the data regardless of its source format and filter the content based on the defined rule.

Some or all of the method steps and/or functions described above may be implemented as computer readable instructions executable by a processor and stored in a non-transitory computer readable memory or storage medium, where the term “non-transitory” does not encompass transitory propagating signals. Such computer readable instructions may exist as a software program in form of source code, object code, executable code, or other formats.

As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty.

Although various embodiments of the present disclosure have been described in detail herein, one of ordinary skill in the art would readily appreciate modifications and other embodiments without departing from the spirit and scope of the present disclosure as stated in the appended claims. It should also be noted that not all of the steps or features described in the figures in this disclosure are required in all embodiments.

What is claimed is:

1. A self-adaptive filtering method, comprising:
creating a tree-structured data model from an input data model, wherein the tree-structured data model includes a root node and a plurality of data branches, each of data branches comprising at least one data node;
identifying at least one of the data nodes of the data branches in accordance with a target locator defined in a filter;
comparing a data value in said at least one of the data nodes with a criterion defined in the filter;
removing, from the tree-structured data model, an invalid data branch when a data value in a data node of the invalid data branch fails to meet the criterion; and
outputting the tree-structured data model with the invalid data branch being removed.

2. The method of claim 1, wherein identifying at least one of the data nodes of the data branches comprises converting a node name of said at least one of the data nodes into a synonymous node name and identifying said at least one of the data nodes of the data branches having the synonymous node name.

3. The method of claim 2, wherein converting the node name comprises translating the node name from one language to another language.

4. The method of claim 1, wherein identifying said at least one of the data nodes of the data branches comprises calling a predefined function stored in a functions pool or using a regular expression to identify a node name of said at least one of the data nodes.

5. The method of claim 1, wherein creating the tree-structured data model from an input data model comprises creating a plurality of tree-structured data models from a plurality of input data models, wherein each of the tree-structured data models includes a root node and a plurality of data branches, each of data branches comprising at least one data node.

6. The method of claim 5, wherein identifying at least one of the data nodes of the data branches comprises identifying, in the tree-structured data models, at least one of the data nodes of the data branches in accordance with a plurality of target locators defined in the filter, each of the target locators corresponding to a respective one of the tree-structured data models.

7. The method of claim 1, wherein identifying said at least one of the data nodes comprises identifying at least one of the data nodes of the data branches in accordance with a plurality of target locators defined in different filters.

8. The method of claim 1, wherein comparing the data value in said at least one of the data nodes comprises comparing the data value in said at least one of the data nodes with a plurality of criteria defined in the filter.

9. A non-transitory computer-readable storage medium encoded with instructions executable by a processor of a computing system, the instructions when executed by the processor causing the processor to:
create a tree-structured data model from an input data model, wherein the tree-structured data model includes a root node and a plurality of data branches, each of data branches comprising at least one data node;
identify at least one of the data nodes of the data branches in accordance with a target locator defined in a filter;
compare a data value in said at least one of the data nodes with a criterion defined in the filter;
remove, from the tree-structured data model, an invalid data branch when a data value in a data node of the invalid data branch fails to meet the criterion; and
output the tree-structured data model with the invalid data branch being removed.

10. The non-transitory computer-readable storage medium of claim 9, wherein the processor to identify said at least one of the data nodes of the data branches comprises the processor to convert a node name of said at least one of the data nodes into a synonymous node name and identify said at least one of the data nodes of the data branches having the synonymous node name.

11. The non-transitory computer-readable storage medium of claim 10, wherein the processor to converting the node name comprises the processor to translate the node name from one language to another language.

12. The non-transitory computer-readable storage medium of claim 9, wherein the processor to identify said at least one of the data nodes of the data branches comprises the processor to call a predefined function stored in a functions pool or to use a regular expression to identify a node name of said at least one of the data nodes.

13. The non-transitory computer-readable storage medium of claim 9, wherein the processor to create the tree-structured data model from an input data model comprises the processor to create a plurality of tree-structured data models from a plurality of input data models, wherein each of the tree-structured data models includes a root node and a plurality of data branches, each of data branches comprising at least one data node.

14. The non-transitory computer-readable storage medium of claim 13, wherein the processor to identify at least one of the data nodes of the data branches comprises the processor to identify, in the tree-structured data models, at least one of the data nodes of the data branches in accordance with a plurality of target locators defined in the filter, each of the target locators corresponding to a respective one of the tree-structured data models.

15. The non-transitory computer-readable storage medium of claim 9, wherein the processor to identify said at least one of the data nodes comprises the processor to identify at least one of the data nodes of the data branches in accordance with a plurality of target locators defined in different filters.

16. The non-transitory computer-readable storage medium of claim 9, wherein the processor to compare the data value in said at least one of the data nodes comprises the processor to compare the data value in said at least one of the data nodes with a plurality of criteria defined in the filter.

17. An apparatus for self-adaptive data filtering, the apparatus comprising:
an extensible data loader to create a tree-structured data model from an input data model, wherein the tree-structured data model includes a root node and a plurality of data branches, each of data branches comprising at least one data node;
a filter chain builder to generate a filter from a configuration file an object pool;
an executor to:
identify at least one of the data nodes of the data branches in accordance with a target locator defined in the filter;
compare a data value in said at least one of the data nodes with a criterion defined in the filter; and
remove, from the tree-structured data model, an invalid data branch when a data value in a data node of the invalid data branch fails to meet the criterion; and
an output composer to output the tree-structured data model with the invalid data branch being removed.

18. The apparatus of claim 17, wherein the executor to identify at least one of the data nodes of the data branches comprises the executor to convert a node name of said at least one of the data nodes into a synonymous node name using a synonym function in a functions pool, and identify said at least one of the data nodes of the data branches having the synonymous node name.

19. The apparatus of claim 18, wherein the executor to convert the node name comprises the executor to translate the node name from one language to another language using a third party translation service available via a wide area network.

20. The apparatus of claim 17, wherein the executor to identify said at least one of the data nodes comprises the executor to identify at least one of the data nodes of the data branches in accordance with a plurality of target locators defined in different filters.
